(19) United States
(12) Patent Application Publication
(10) Pub. No.: US 2025/0057354 A1
(43) Pub. Date: Feb. 20, 2025

(54) MACHINE FOR PREPARING AND EXTRACTING A HOT BEVERAGE

(71) Applicant: GISE CAFFE' S.R.L., Gaggio Montano (Bologna) (IT)

(72) Inventor: Giovanni ACCURSI, Alto Reno Terme (Bologna) (IT)

(21) Appl. No.: 18/720,348

(22) PCT Filed: Dec. 14, 2022
(86) PCT No.: PCT/IB2022/062200

§ 371 Date: Jun. 14, 2024

(30) Foreign Application Priority Data
Dec. 17, 2021 (IT) 102021000031652

(51) Int. Cl. A47J 31/36; A47J 31/40; A47J 31/52; B65D 85/804

(52) U.S. Cl. CPC A47J 31/3633; A47J 31/3628; A47J 31/407; A47J 31/52; B65D 85/8043

(57) ABSTRACT

A machine for preparing and extracting a hot beverage from a capsule includes a frame having an inlet opening for the capsule; a first fixed extraction unit including a housing; a second extraction unit movable along a linear trajectory between a first non-operating end position away from the first unit, and a second operating end position wherein the second unit is moved towards the first unit to insert the capsule in the housing for extracting the beverage by feeding a pressurised hot fluid; a command and control unit activates/deactivates the pressurised fluid; a device for detecting the capsule intercepts an outer surface of the capsule when it is inserted; the detection device is connected to the control unit to send an enabling signal for activation of the pressurised fluid.

### TECHNICAL FIELD

This invention relates to a machine for preparing and extracting a hot beverage.

### BACKGROUND ART

The machine according to the invention is of the type using single capsules, preferably of the single-dose type, from which the hot beverage is extracted (such as coffee, tea, milk, camomile and similar beverages) by extracting the product with pressurised hot fluid.

The capsules used for this type of machine basically comprise a capsule body forming a chamber having a bottom and an opening of the capsule body delimited by an annular collar protruding transversally with respect to the body.

A dose of extraction product is housed in the chamber.

The opening of the capsule is sealed by a piece of film adherent to the annular collar.

The prior art machines using these capsules basically comprise:
a load-bearing frame having an inlet opening for the capsule;
a first fixed extraction unit positioned in the load-bearing frame and comprising a housing for the capsule and means for perforating and passage of the mixture, to obtain the extraction of the beverage, positioned on the bottom of the housing;
a second movable extraction unit, positioned inside the frame, and movable inside the frame along a linear trajectory, in both directions, between a first non-operating end position away from the first fixed extraction unit (wherein the second movable extraction unit is positioned close to the inlet opening), and a second operating end position wherein the second movable extraction unit is moved towards the first fixed extraction unit in such a way as to move the capsule from an inlet position in the frame to a housing position in the first fixed unit for extracting the beverage by feeding a pressurised hot fluid.

Means for supporting the capsule are interposed between the movable extraction unit and the frame.

Usually, these supporting means may comprise a pair of protruding arms, positioned on both sides of the movable extraction unit, configured to retain the capsule entering (by falling) from the opening present on the frame. The pair of arms is configured to move along the frame synchronised with the movable extraction unit. These arms can move between an operating position, with the ends of the arms positioned at a reciprocal reduced distance, for retaining the capsule (with the extraction unit movable in the first non-operating position), to a non-operating position, wherein the ends of the arms are at a mutual distance greater than the previous distance so as to free the capsule at the housing of the capsule in the fixed dispensing extraction unit (with the movable extraction unit in the second operating position).

The movable extraction unit has a head provided with perforating elements which are able to perforate, according to a first solution, the sheet of film (if the capsule is inserted in the frame with the bottom facing towards the fixed extraction unit) or, according to a second solution, the perforating elements perforate the bottom of the capsule (if the capsule is inserted in the frame in the opposite direction to the previous one).

The head of the movable extraction unit is provided with ducts for the passage of the pressurised hot fluid to be introduced into the capsule after the capsule has been perforated.

The extraction of the beverage occurs by the combination given by the increase in the pressure inside the capsule supplied by the fluid entering and by the presence of the perforating means positioned on the bottom of the housing of the first fixed extraction unit which allow an opening in the capsule to be obtained for the passage of the beverage obtained from the product/fluid mixture towards the dispensing conduits of the extracted beverage made in the first fixed extraction unit.

Currently, the wide use of these machines for extracting beverages has consequently also led to a considerable increase in the production of capsules which can be used on these machines for the consumption of such beverages.

This increase in the production of the capsules has opened the way for a parallel production of “non-original” capsules or compatible capsules which have spread on the market as an alternative to the original capsules made specifically for each type of machine.

However, this type of compatible capsule product has drawbacks due to:
low quality of the product contained in the capsules with consequent extracted beverage of reduced quality for the user;
outer configuration of the capsule not always precise and matching the housing present in the fixed extraction unit which can lead to a partial or zero dispensing of the beverage, with possible damage also to the parts of the machine.

For this reason, the manufacturers of machines and relative capsules dedicated to their machines are seeking solutions, in particular on the machine, which are able to detect, before the extraction step, the originality of the capsule inserted in such a way as to block the machine before use of the machine in the case of the presence of a non-original capsule.

### AIM OF THE INVENTION

The aim of this invention is to provide a machine for preparing and extracting a hot beverage that overcomes the above-mentioned drawbacks of the prior art.

More specifically, the aim of this invention is to provide a machine for preparing and extracting a hot beverage which is able to detect in real time the originality of the capsule before the step of extracting the beverage.

A further aim of the invention is to provide a machine for preparing and extracting a hot beverage with a detection system which is simple, practical and interacting safely with the capsule.

Said aims are fully achieved by the machine for preparing and extracting a hot beverage according to the invention as characterised in the appended claims.

### BRIEF DESCRIPTION OF THE DRAWINGS

The main features of the invention will become more apparent from the following detailed description of a preferred, non-limiting embodiment, illustrated purely by way of example in the accompanying drawings, in which:

FIG. 1 is a perspective view, with some parts cut away to better illustrate others, of a machine for preparing and extracting a hot beverage according to the invention;

FIG. 2 is a top plan view of the machine of FIG. 1;

FIG. 3 is a top plan view of the machine of FIG. 2 in a first non-operating configuration, with some parts cut away and others in cross section;

FIG. 4 is a top plan view of the machine of FIG. 2 in a second operating configuration, with some parts cut away and others in cross section;

FIGS. 5 and 6 are, respectively, a front view and a perspective view from below of an example of a capsule which can be used in the machine of the above-mentioned drawings.

### DETAILED DESCRIPTION OF PREFERRED EMBODIMENTS OF THE INVENTION

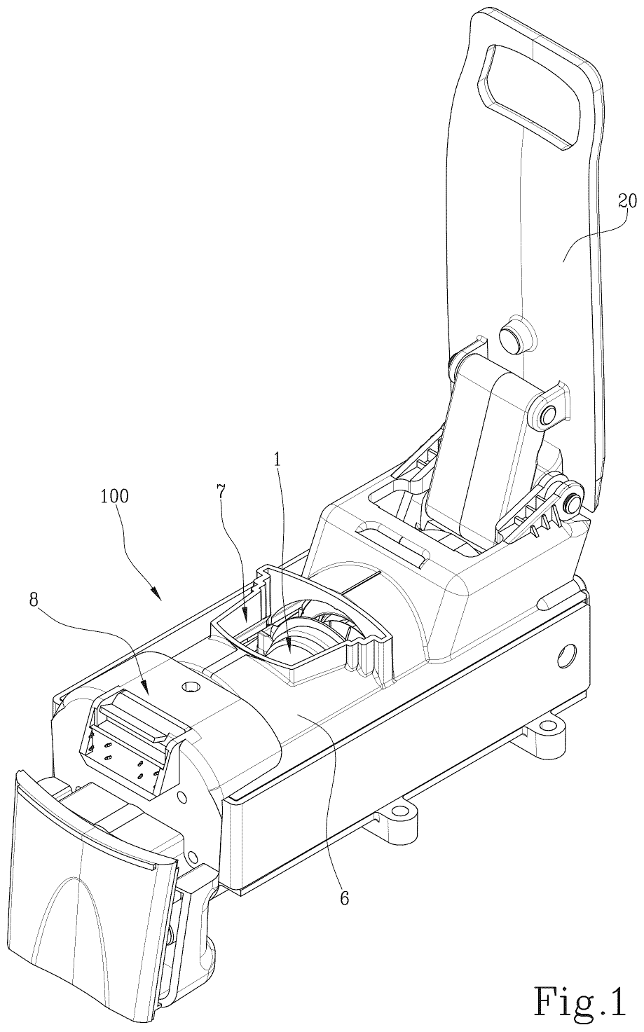

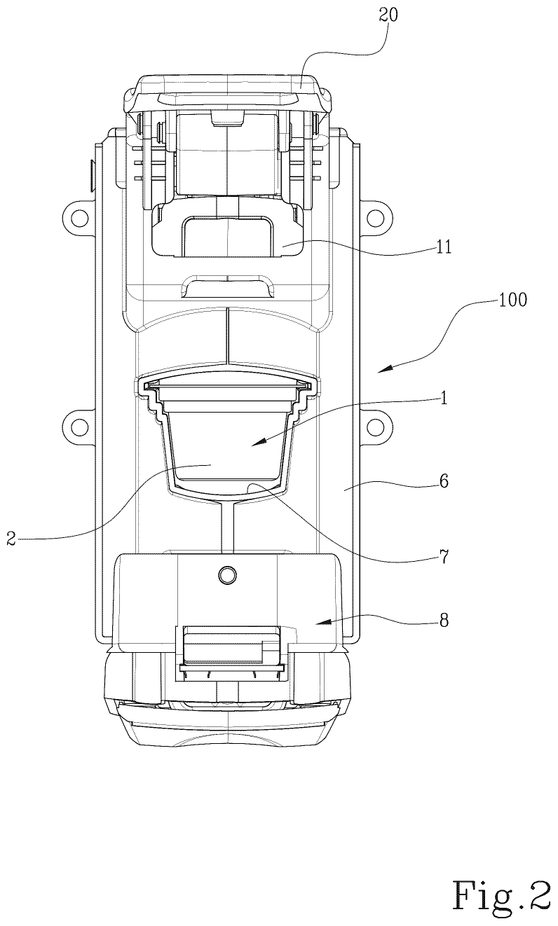

With reference to the accompanying drawings, in particular FIGS. 1 and 2, the machine according to the invention, labelled 100 in its entirety, is used with single capsules, preferably of the single-dose type, from which the hot beverage is extracted (such as coffee, tea, milk, camomile and similar beverages) by extracting the product with pressurised hot fluid.

The capsule 1 which can be used in the machine 100 basically comprises a capsule body 2, forming a chamber, having a bottom 3 and an upper opening 4 delimited by an annular collar 5 protruding transversally relative to the capsule body 2.

A sheet for sealing the chamber (not illustrated) is positioned on the opening 4 and the collar 5.

The chamber houses at least one dose of product.

FIGS. 1 and 2 illustrate a part of the machine for preparing and extracting a hot beverage from the capsule 1, that is to say, the operating parts of relevance for the invention.

The machine 100 comprises a load-bearing frame 6 having an inlet opening 7 for the capsule 1.

Moreover, the machine 100 comprises a first fixed extraction unit 8 associated with the frame 6 and comprising a matching housing 9 for the capsule 1 and means 10 for perforating and passage of the mixture, to obtain the extraction of the beverage.

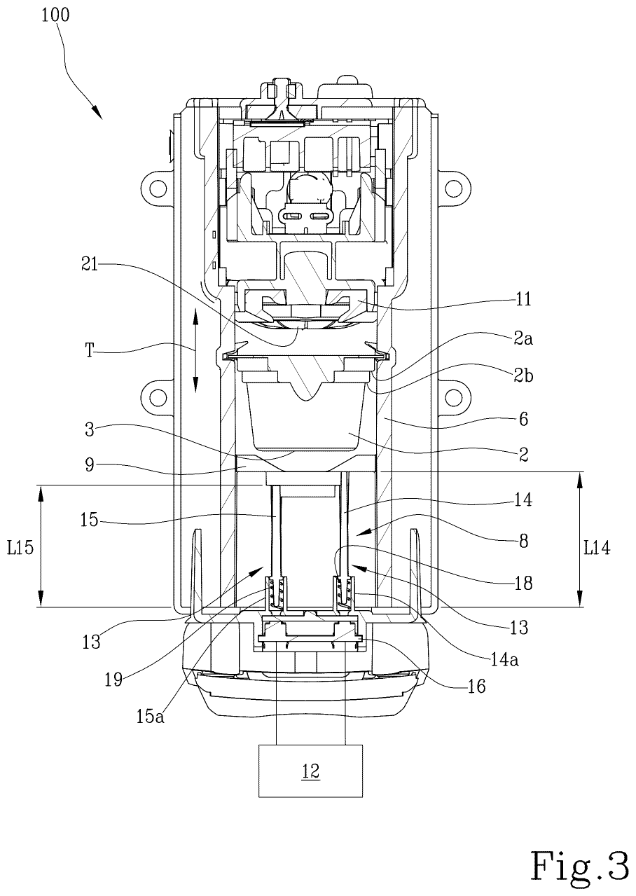

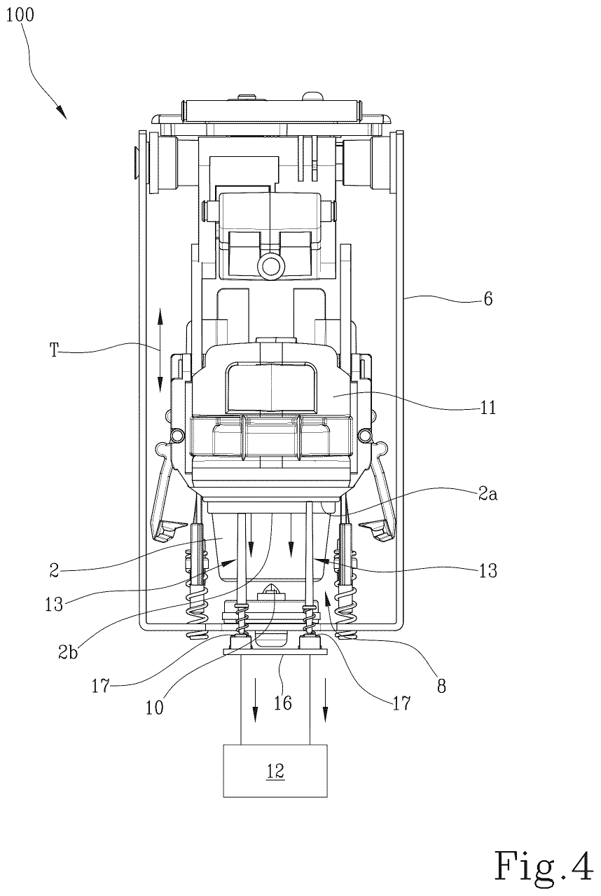

The machine 100 also comprises a second movable extraction unit 11, positioned inside the frame 6, and movable inside the frame 6 along a linear trajectory T, in both directions, between
a first non-operating end position away from the first fixed extraction unit 8 (FIG. 3), wherein the second movable extraction unit 11 is positioned close to the inlet opening 7, and
a second operating end position (FIG. 4) wherein the second movable extraction unit 11 is moved towards the first fixed extraction unit 8 in such a way as to move the capsule 1 from an inlet position to a position for insertion in the housing 9 of the first fixed unit 8 for extracting the beverage by feeding a pressurised hot fluid.

Moreover, the machine 100 comprises a command and control unit 12 configured for activating/deactivating the pressurised fluid for extracting the beverage (the unit is schematically illustrated with a block in FIGS. 3 and 4).

As illustrated (again see FIGS. 3 and 4), the machine 100 comprises a device 13 for detecting the capsule 1, positioned close to the first fixed extraction unit 8.

The device 13 for detecting the capsule 1 has at least two contact elements 14, 15 positioned on the first fixed extraction unit 8 and configured to intercept, at the insertion of the capsule body 2 in the housing 9 of the first extraction unit 8, a corresponding and different protruding outer surface 2a, 2b of contact of the capsule body 2.

In light of this, each contact element 14, 15 is slidable along the first extraction unit 8, parallel to the trajectory T, between a first advanced non-operating position, and a second withdrawn contact position, at the intercepting of the corresponding protruding surface 2a, 2b of contact of the capsule body 2 inserted in the housing 9.

The detection device 13 is connected to the command and control unit 12 and configured to send at least one corresponding enabling signal for activating the pressurised fluid by the command and control unit 12.

In other words, the machine has a system which is able to detect, before the extraction step and quickly and easily, whether the capsule inserted is the correct and original one and consequently give consent to the command and control unit to start the extraction procedure. Without this consent, the command and control unit 12 does not perform any type of activity on the machine.

It should be noted that the second movable extraction unit 11 is connected and controlled by an outer manual lever 20 which allows the second extraction unit 11 to be moved between the two non-operating and operating positions and vice versa.

The second movable extraction unit 11 is also provided with a unit 21 for perforating the capsule 1 to allow the flow of the pressurised hot fluid.

As illustrated,
the capsule 1 which can be used in the machine 100 comprises at least two different annular portions protruding from the capsule body 2 made at different distances from the bottom 3 of the capsule body 2 and in such a way as to define the two corresponding different outer contact surfaces 2a, 2b, positioned, in use, transversal to the linear trajectory (T), for the relative two contact elements 14, 15 configured to intercept the corresponding outer contact surface 2a, 2b.

It should be noted that the two contact elements 14, 15 are housed in a corresponding seat 14a, 15a made in the first fixed extraction unit 8 and slidable inside the corresponding seat 14a, 15a, parallel to the trajectory of movement T, between the first advanced non-operating position (see FIG. 3), and the second withdrawn position, at the intercepting of the corresponding protruding surface 2a, 2b of contact of the capsule body 2 inserted in the housing 9.

In light of this, each contact element 14, 15 is always in contact with the corresponding protruding surface 2a, 2b during the passage between the first advanced non-operating position and the second withdrawn operating position.

Preferably, the two contact elements 14 and 15 are positioned on the fixed extraction unit 8, spaced from each other in such a way as to intercept the corresponding contact surfaces 2a and 2b at different points along the circumference of the capsule body 2.

It should be noted that each contact element 14 and 15 comprises a rod having a proximal operating end for intercepting the corresponding protruding outer surface 2a, 2b of contact of the capsule body 2.

This proximal end of each contact element 14 and 15 is positioned inside the housing 9 of the fixed extraction unit 8 even at the first operating position.

Each rod has a distal end positioned close to a foot 16 positioned in the fixed extraction unit 8 (at a relative end opposite the perforating zone of the capsule body).

Each foot 16 is equipped with a contact pushbutton 17 (for example, a microswitch) configured to send a respective enabling signal to the command and control unit 12 upon contact with the distal end of the corresponding contact element 14, 15 in the second withdrawn operating contact position.

As illustrated, the length L14 of the first contact element 14 is different to the length L15 of the second contact element 15.

This difference is necessary in the example illustrated, since the protruding contact surfaces 2a, 2b are positioned at different heights along the capsule body 2, but the ends of the elements 14 and 15 must come into contact simultaneously during the entrance of the capsule 1 into the housing 9.

Preferably, each contact element 14, 15 is provided with a spring 18, 19 positioned inside the seat 14a, 15a, fitted on each contact element 14, 15, and configured to maintain or restore each contact element 14, 15 in the first non-operating position.

More precisely, each rod forming one of the contact elements 14 or 15 has an annular contact protrusion for one end of the spring 18 or 19 also positioned inside the seat 14a or 15a.

In turn, the spring 18 or 19 comes into contact, at the other relative end, with a narrow surface of the seat 14a and 15a.

When the rod comes into contact with the protruding surface 2a or 2b of the capsule 1 entering the housing 9, the rod slides inside the seat 14a or 15a compressing the spring 18 or 19 up to the maximum withdrawn position wherein the distal end of the rod comes into contact with the pushbutton 17.

Subsequently, after completing the step of extracting the beverage, the capsule 1 is moved away from the housing 9 and the rods, due to the pushing action of the springs 18 or 19, return to their advanced non-operating position.

It should be noted that the frame 6 has an inlet opening 7 having a profile shaped to match the outer profile of the capsule 1.

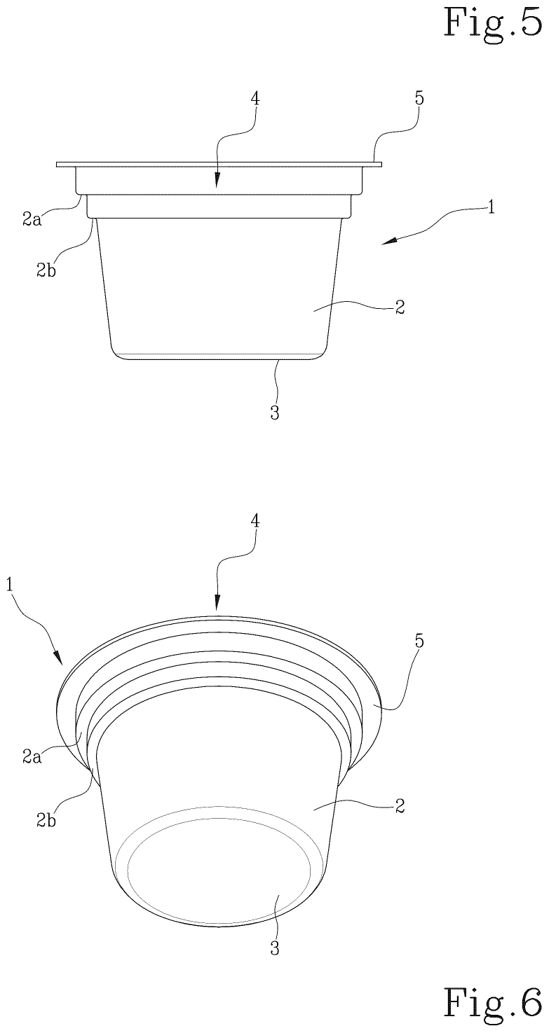

As illustrated in FIGS. 5 and 6, an example of a capsule 1 which can be used in the machine 100 described above comprises a capsule body 2 forming a chamber having a bottom 3 and an upper opening 4 delimited by an annular collar 5 protruding transversely relative to the capsule body 2 and on which a sheet for sealing the chamber is positioned. A dose of product is housed inside the chamber.

This capsule comprises the capsule body 2 having at least two annular portions protruding from the capsule body 2 at different distances from the bottom 3 of the capsule body 2 and in such a way as to define two different outer surfaces 2a, 2b parallel to the collar 5 (and at different heights with respect to the collar).

Preferably, the two annular portions extend along the entire circumference of the capsule body 2 in such a way as to define corresponding continuous annular outer surfaces 2a, 2b.

As mentioned above, the machine 100 has a command and control unit which, when the machine is switched on, is programmed in a standby state. After inserting the capsule 1 in the frame 3, the second movable unit 11 is activated in such a way as to allow the capsule 1 to enter the matching housing 9. If the capsule is of the correct or original type, the protruding surface(s) 2a and 2b are intercepted by the contact elements 14 and 15 which, under the thrust of the surfaces, withdraw along their corresponding seat in such a way as to come into contact with the pushbuttons 17.

The pushbuttons close a contact (preferably electrical) in such a way as to send an enabling signal to the control unit, which at that point can start, when requested by the user, the activation of the flow of the hot fluid under pressure towards the capsule.

If the capsule is not of the type which can be used in the machine, the contact elements cannot reach the pushbuttons and, consequently, the control unit remains in a blocked state and does not allow the activation of the flow of hot fluid.

The invention also provides a method for preparing and extracting a hot beverage from a capsule 1 comprising a capsule body 2 forming a chamber having a bottom 3 and an upper opening 4 delimited by an annular collar 5 protruding transversely relative to the capsule body 2 on which a sheet for sealing the chamber is positioned and where a dose of product is housed in the chamber.

The method comprises the steps of:
inserting the capsule 2 in an inlet opening 7 of a machine 100 for preparing and extracting the hot beverage from the capsule 1 and at a second movable extraction unit 11 positioned in a first non-operating end position;
moving the second movable unit 11 with the capsule 1, along a linear trajectory T, towards a first fixed extraction unit 8 having a matching housing 9 for the capsule 1 and means 10 for perforating and passage of the mixture, to obtain the extraction of the beverage;
locking the capsule inside the housing 9;
extracting the beverage from the capsule 1 by feeding a hot fluid under pressure.

During the steps of approaching and locking the capsule 1 in the housing 9 there are the steps of:
intercepting and contacting, using at least two contact elements 14, 15 present on the first extraction unit 8 of a corresponding and different protruding outer surface 2a, 2b of contact of the capsule body 2;
sliding (withdrawing) each contact element 14, 15 along the first extraction unit 8, parallel to the trajectory T, between a first advanced non-operating position, and a second withdrawn position of constant contact with the corresponding protruding surface 2a, 2b of contact of the capsule body 2 during insertion in the housing 9;
activating the extraction of the hot beverage only when a corresponding signal for allowing activation of the pressurised fluid by the two contact elements 14, 15 is sent.

The preset aims are achieved with a machine structured in this way thanks to a detection device which is extremely simple, but effective and precise and which makes it possible to use the machine only with the capsules decided by the machine manufacturer.

The components of the detection device are reduced to the essential minimum and do not increase the overall dimensions of the machine.

The presence of the two contact elements makes it possible to increase the safety of the dispensing, since if the capsule is not correctly centred in the housing, the two contact elements do not give consent to the start of the dispensing. This is possible thanks to the fact that the two contact surfaces are linear, whilst it would be more difficult on, for example, tapered surfaces, which are usually the case for the capsule bodies used in these machines.

1. A machine for preparing and extracting a hot beverage from a capsule comprising a capsule body forming a chamber having a bottom and an upper opening delimited by an annular collar protruding transversely relative to the capsule body on which a sheet for sealing the chamber is positioned; a dose of product being housed in said chamber; the machine comprising:
a load-bearing frame having an inlet opening for the capsule;
a first fixed extraction unit associated with the frame and comprising a matching housing for the capsule and means for perforating and passage of the mixture, to obtain the extraction of the beverage;
a second movable extraction unit, positioned inside the frame, and movable inside the frame along a linear trajectory, in both directions, between a first non-operating end position away from the first fixed extraction unit, wherein the second movable extraction unit is positioned close to the inlet opening, and a second operating end position wherein the second movable extraction unit is moved towards the first fixed extraction unit in such a way as to move the capsule from an inlet position to a position for insertion in the housing of the first fixed unit for extracting the beverage by feeding a pressurised hot fluid;
a command and control unit configured to activate/deactivate the pressurised fluid for extracting the beverage,
characterised in that it comprises a device for detecting the capsule having:
at least two contact elements positioned on the first fixed extraction unit and configured to intercept, at the insertion of the capsule body in the housing of the first extraction unit, a corresponding and different protruding outer surface of contact of the capsule body; each contact element being slidable along the first extraction unit, parallel to the trajectory, between a first advanced non-operating position, and a second withdrawn contact position, at the intercepting of the corresponding protruding surface of contact of the capsule body inserted in the housing;
the detection device being connected to the control unit and configured to send at least one corresponding enabling signal for activating the pressurised fluid by the control unit.

2. The machine according to claim 1, wherein the capsule comprises at least two different annular portions protruding from the capsule body and made at different distances from the bottom of the capsule body and in such a way as to define the two corresponding different outer contact surfaces, positioned, in use, transversal to the linear trajectory, for the relative two contact elements configured to intercept a corresponding outer contact surface.

3. The machine according to claim 1, wherein the two contact elements are housed in a corresponding seat made in the first fixed extraction unit and slidable inside the corresponding seat, parallel to the trajectory of movement between the first advanced non-operating position and the second withdrawn position, at the intercepting of the corresponding protruding surface of contact of the capsule body inserted in the housing; each contact element between the first advanced non-operating position and the second withdrawn position being always in contact with the corresponding protruding surface.

4. The machine according to claim 1, wherein each contact element comprises a rod having a proximal operating end for intercepting the corresponding protruding outer surface of contact of the capsule body and positioned inside the housing of the fixed extraction unit; each rod having a distal end positioned close to a foot located in the fixed extraction unit; said foot being provided with a contact pushbutton configured to send a respective enabling signal to the command and control unit upon contact with the distal end of the corresponding contact element in said second withdrawn operating contact position.

5. The machine according to claim 1, wherein a first contact element has a length which is different from the length of the second contact element.

6. The machine according to claim 1, wherein each contact element is provided with a spring positioned inside the seat, fitted on each contact element, and configured to maintain or restore each contact element in the first non-operating position.

7. The machine according to claim 1, wherein the frame has an inlet opening having a profile shaped to match the outer profile of the capsule.

8. A capsule which can be used in the machine according to claim 1 and comprising a capsule body forming a chamber having a bottom and an upper opening delimited by an annular collar protruding transversely relative to the capsule body on which is positioned a sheet for sealing the chamber; a dose of product being housed in said chamber;
characterised in that it comprises
the capsule body comprising at least two annular portions protruding from the capsule body at different distances from the bottom of the capsule body and in such a way as to define two different outer surfaces parallel to the collar.

9. The capsule according to claim 10, wherein the two annular portions extend along the entire circumference of the capsule body in such a way as to define corresponding continuous annular outer surfaces.

10. A method for preparing and extracting a hot beverage from a capsule comprising a capsule body forming a chamber having a bottom and an upper opening delimited by an annular collar protruding transversely relative to the capsule body on which a sheet for sealing the chamber is positioned; a dose of product being housed in said chamber;
the method comprising the steps of:
inserting the capsule in an inlet opening of a machine for preparing and extracting the hot beverage from the capsule and at a second movable extraction unit positioned in a first non-operating end position;
moving the second movable unit with the capsule, along a linear trajectory, towards a first fixed extraction unit having a matching housing for the capsule and means for perforating and passage of the mixture, to obtain the extraction of the beverage;
locking the capsule inside the housing;
extracting the beverage from the capsule by feeding a hot fluid under pressure;
characterised in that during the steps of moving the capsule towards and locking the capsule in the housing there are the steps of:
intercepting and contacting, using at least two contact elements present on the first unit, for extracting a corresponding and different protruding outer surface of contact of the capsule body;
sliding each contact element along the first extraction unit, parallel to the trajectory, between a first advanced non-operating position, and a second withdrawn position of constant contact with the corresponding protruding surface of contact of the capsule body during insertion in the housing;
activating the extraction of the hot beverage only when a corresponding signal for allowing activation of the pressurised fluid by the two contact elements is sent.
